(19) United States
(12) Patent Application Publication
(10) Pub. No.: US 2016/0298913 A1
(43) Pub. Date: Oct. 13, 2016

(54) HEAT SINK

(71) Applicant: Jinhe GUO, Guangdong (CN)

(72) Inventor: Jinhe GUO, Dongguan City (CN)

(21) Appl. No.: 14/904,098

(22) PCT Filed: Aug. 14, 2013
(86) PCT No.: PCT/CN2013/081421

§ 371 Date: Jun. 3, 2016

(30) Foreign Application Priority Data
Feb. 27, 2013 (CN) 201310062921.6

(51) Int. Cl. F28F 13/06; F28F 3/04; F28F 13/18; F21V 29/77; F21V 29/83

(52) U.S. Cl. CPC F28F 13/06; F21V 29/77; F21V 29/83; F28F 13/18; F28F 3/04; F28F 3/048; F28D 2021/0029

(57) ABSTRACT

A heat sink includes a heat-conducting base having a top surface, and a plurality of primary heat-dissipating fins perpendicularly mounted on the top surface of the heat-conducting base, spaced apart from each other and arranged circumferentially to form a cylindrical convection tunnel, wherein a spacing between every two adjacent primary heat-dissipating fins forms a thermal convection tunnel, and each thermal convection tunnel is open to the cylindrical convection tunnel.

### TECHNICAL FIELD

The present invention relates to a heat sink.

### BACKGROUND

A LED (light emitting diode) illuminator with a COB (chip on board) packaging construction generally includes an LED module, the COB packaging construction, a reflecting lampshade mounted on the LED module, and a heat sink mounted at a base of the LED module. The heat sink generally includes a hollow heat-conducting shell and a plurality of fins that are mounted at the sidewall of the heat-conducting shell and spaced apart from each other. The base has a top surface attached to a chip of the LED module; and a bottom surface attached to the heat-conducting shell, which has a cavity located at a central portion of the bottom surface that is directly interfaced with the chip. Therefore, the heat of the base decreases radially away from the chip around the chip, and the central portion of the base has a highest level of heat. The heat-conducting shell defines a closed cavity where air is not circulating. The heat at the center portion of the base is emitted only through the still air within this closed cavity of the heat-conducting shell. Such a heat sink dissipates heat only through heat conduction, rather than through heat convection, and thus has a poor heat dissipation effect. Significant amounts of heat accumulating in the closed cavity of the heat-conducting shell will undesirably reduce the heat dissipation efficiency of the LED module, and more particularly so for high-powered chips with convergent heat.

### SUMMARY

The present invention addresses the problems of a conventional heat sink that dissipates heat inefficiently.

Some embodiments of the present invention relate to a heat sink including a heat-conducting base having a top surface; and a plurality of primary heat-dissipating fins mounted perpendicularly on the top surface of the heat-conducting base, which are spaced apart from each other and arranged circumferentially to form a cylindrical convection tunnel, wherein a spacing between every two adjacent primary heat-dissipating fins forms a thermal convection tunnel, and each thermal convection tunnel is open to the cylindrical convection tunnel.

Each primary heat-dissipating fin is preferably plate-like. Each thermal convection tunnel includes an inner section proximal to the center portion of the top surface, and an outer section proximal to the periphery of the top surface, the outer section being larger than the inner section. The thermal convection tunnel widens gradually from the inner section to the outer section. The thermal convection tunnels are arranged circumferentially and evenly around the cylindrical convection tunnel. Further, the vertical projection of an axis of the cylindrical convection tunnel onto the top surface of the heat-conducting base defines a center point, and an axis of each thermal convection tunnel extends through the center point.

The heat sink further preferably includes secondary heat-dissipating fin modules having the same number as the thermal convection tunnels. Each secondary heat-dissipating fin module includes two opposite secondary heat-dissipating fins, where the secondary heat-dissipating fins are mounted perpendicularly on the top surface of the heat-conducting base and are arranged circumferentially around the primary heat-dissipating fins. Additionally, a spacing between two secondary heat-dissipating fins forms a secondary thermal convection tunnel, where each secondary thermal convection tunnel and a corresponding thermal convection tunnel cooperatively form a tunnel with a straight axis.

The heat sink further preferably includes tertiary heat-dissipating fin modules having the same number as the secondary thermal convection tunnels, where each tertiary heat-dissipating fin module includes two opposing tertiary heat-dissipating fins. The tertiary heat-dissipating fins are mounted perpendicularly on the top surface of the heat-conducting base, and are arranged circumferentially around the secondary heat-dissipating fins. A spacing between two tertiary heat-dissipating fins forms a tertiary thermal convection tunnel. Each tertiary thermal convection tunnel, a corresponding secondary thermal convection tunnel, and a corresponding thermal convection tunnel cooperatively form a tunnel with a straight axis.

The heat sink further preferably includes a plurality of auxiliary heat-dissipating fins disposed between every two adjacent tertiary heat-dissipating fin modules and/or between every two adjacent secondary heat-dissipating fin modules, wherein each auxiliary heat-dissipating fin is mounted perpendicularly on the top surface of the heat-conducting base.

The heat-conducting base, the primary heat-dissipating fins, the secondary heat-dissipating fins, the tertiary heat-dissipating fins and the auxiliary heat-dissipating fins are preferably monolithic.

Each primary heat-dissipating fin, each secondary heat-dissipating fin, each tertiary heat-dissipating fin or auxiliary heat-dissipating fin has a plurality of raised lines spaced apart from each other and mounted on a sidewall thereof.

Each secondary heat-dissipating fin is preferably plate-like. Each secondary thermal convection tunnel has an inner section proximal to the thermal convection tunnel, and an outer section proximal to the periphery of the top surface, and the inner section is smaller than the outer section.

Each tertiary heat-dissipating fin is preferably plate-like. Each tertiary thermal convection tunnel has an inner section proximal to the secondary thermal convection tunnel, and an outer section proximal to the periphery of the top surface, the inner section being smaller than the outer section.

The surface of the heat-conducting base is preferably a planar surface, a concave surface, or a convex surface.

The heat sink is preferably plated with a black radiation layer.

Beneficial effects of the present invention are as follows:

The heat sink defines a heat-convection mechanism for transferring heat in all directions. The heat emitted from a high-powered chip can be dissipated out of the heat sink through heat convection, heat conduction, and heat radiation, even though the heat sink does not have a fan mounted on the primary heat-dissipating fins thereof or a liquid convection tube therein. The heat sink has a simple structure that provides a heat-convection dissipating mechanism that a conventional dynamic heat sink generally provides, but does not make any noise or vibration to avoid affecting the operation of the LED chip. The heat-convection dissipating mechanism has an omnidirectional heat convection effect and exchanges heat efficiently, which is beneficial for high-powered chips with convergent heat.

Additionally, the heat sink is plated with a black radiation layer so that the heat sink can transfer heat efficiently through heat radiation.

Furthermore, the top surface of the heat-conducting base can be a planar surface, a convex surface, or a concave surface to adjust a heat dissipation area of a longitudinal airflow, so the heat sink can dissipate heat efficiently no matter what chips are mounted thereto.

In conclusion, the heat sink can transfer heat through heat conduction, heat convection, and heat radiation. The heat sink can dissipate heat efficiently in all directions.

### BRIEF DESCRIPTION OF THE DRAWINGS

FIG. 1 is an isometric view of some embodiments of a heat sink.

FIG. 2 is a perspective top view of the heat sink of FIG. 1.

FIG. 3 is a side view of the artificial heat sink of FIG. 1.

### DETAILED DESCRIPTION

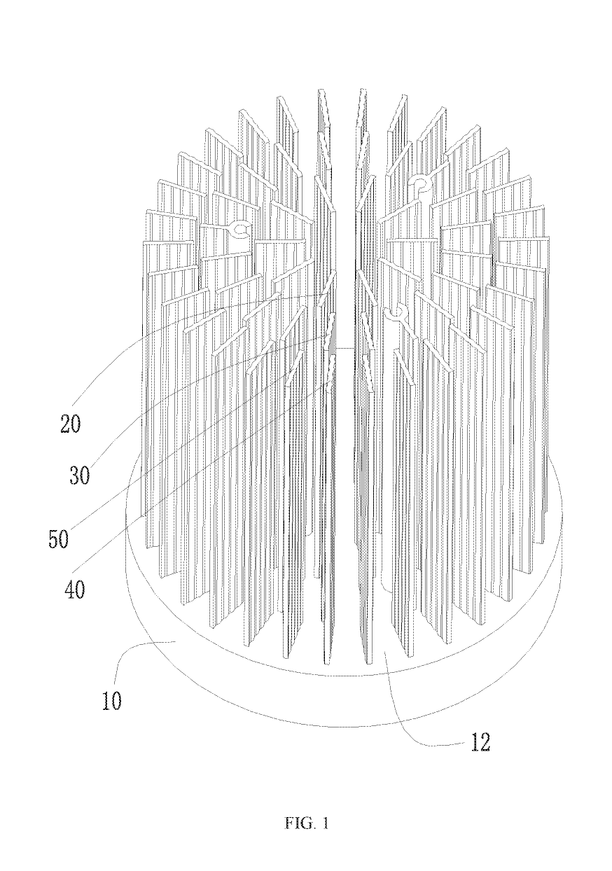

Referring to FIG. 1, a preferred embodiment of a heat sink includes a heat-conducting base 10 and a plurality of primary heat-dissipating fins 20. The heat-conducting base 10 includes a top surface 12, a bottom surface opposite to the top surface 12, and a side surface between the top surface 12 and the bottom surface. In this preferred embodiment, the heat-conducting base 10 is a cylinder. The top surface is planar. In other embodiments, the heat conducting base 10 is cubic.

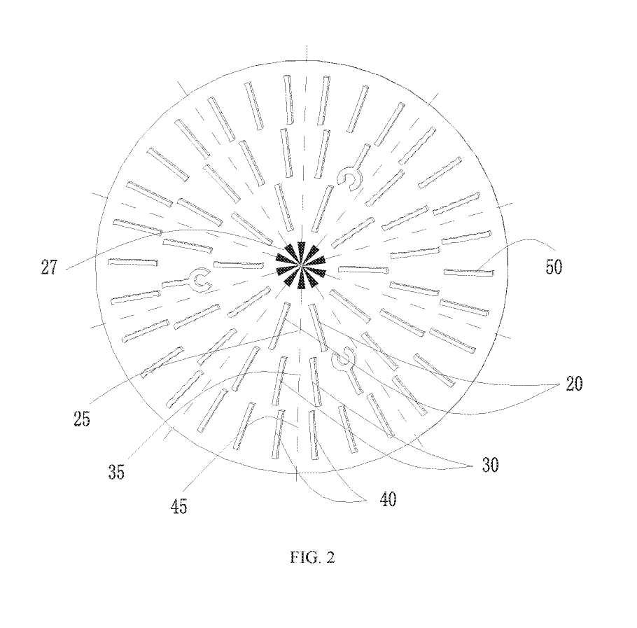

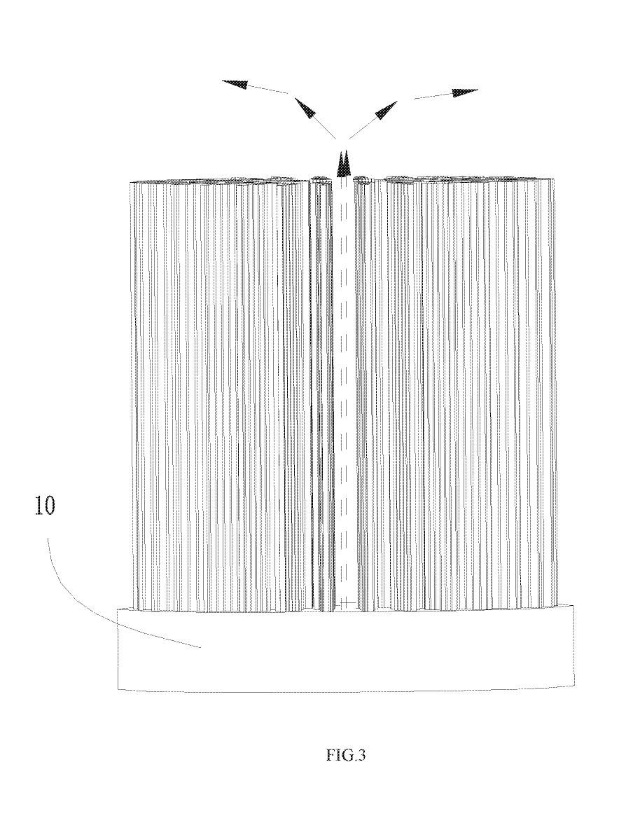

Referring to FIG. 2 and FIG. 3, each primary heat-dissipating fin 20 is perpendicularly mounted on the top surface 12 of the heat-conducting base 10. The primary heat-dissipating fins 20 spaced apart from each other and are arranged circumferentially to form a cylindrical convection tunnel 27. A spacing between every two adjacent primary heat-dissipating fins 20 forms a thermal convection tunnel 25. Each thermal convection tunnel 25 is open to the cylindrical convection tunnel 27.

In this preferred embodiment, each primary heat-dissipating fin 20 is plate-like. Each thermal convection tunnel 25 has an inner section proximal to the center portion of the top surface 12, and an outer section proximal to the periphery of the top surface 12. The outer section is larger than the inner section. The thermal convection tunnel 25 widens gradually from the inner section to the outer section. The atmospheric pressure in the inner section is higher than the atmospheric pressure in the outer section, which causes the airflow through the heat sink to move faster. Compared to a conventional heat sink with parallel pins, a heat sink such as that shown in FIGS. 1-3 has a faster thermal convection air speed.

The thermal convection tunnels 25 are arranged circumferentially and evenly around the cylindrical convection tunnel 27. The vertical projection of an axis of the cylindrical convection tunnel 27 onto the top surface 12 of the heat-conducting base 10 defines a center point. An axis of each thermal convection tunnel 25 extends through the center point, so that the heat transmission between hot air in the cylindrical convection tunnel 27 and cool air out of the heat sink is efficient in all directions. In other embodiments, each heat dissipating fin is cylindrical.

For example, the heat sink is used in a LED (light emitting diode) illuminator with a COB (chip on board) packaging construction. An LED chip of the LED illuminator is mounted on the central portion of the bottom surface of the heat-conducting base 10. The heat emitted from the LED chip transfers from the bottom surface to the top surface 12 of the heat-conducting base 10 through heat conduction. Some of the heat of the top surface 12 transfers to the end of each primary heat dissipating fin 20

Additionally, according to features of the LED chip, the temperature of the central portion of the LED chip is higher than the temperature at other portions of the LED chip, whereby the temperature of the central portion of the top surface 12 is higher than the temperature at other portions of the heat sink. The heat emitted from the LED chip is thereby convergent in the cylindrical convection tunnel 27. The density of air outside of the heat sink is greater than the density of air in the cylindrical convection tunnel 27. Thus, cool air will flow into the cylindrical convection tunnel 2 through each thermal convection tunnel 25. The density of air in the lower area of the cylindrical convection tunnel 27 is greater than the density of air in the upper area of the cylindrical convection tunnel 27, which makes the hot air in the cylindrical convection tunnel 27 rise out of the heat sink. The heat sink defines a heat-convection mechanism for transferring heat in all directions. The heat emitted from the LED chip can be dissipated out of the heat sink through heat convection, even though the heat sink does not have a fan mounted on the primary heat-dissipating fins 20 thereof or a liquid convection tube therein. The heat sink has a simple structure that provides a heat-convection dissipating effect that a dynamic heat sink generally provides, but does not make any noise or vibration to avoid affecting the operation of the LED chip. The heat-convection mechanism has an omnidirectional heat convection effect and transfers heat efficiently, which is beneficial for high-powered chips with convergent heat.

In this preferred embodiment, the top surface 12 of the heat-conducting base 10 is a concave surface. Compared with a plane surface, the temperature of the recessed portion of the top surface 12 is far higher than the temperature of the raised periphery of the top surface 12, which facilitates improving heat-convection speed. In other embodiments, the top surface 12 is a convex surface. Compared with a plane surface, the temperature of the raised portion and the temperature of the recessed periphery of the top surface 12 are almost the same, which reduces the heat-convection speed, but improves the heat-conduction speed. Heat can transfer rapidly from the center portion to the periphery of the heat-conducting base 10.

The heat sink further includes secondary heat-dissipating fin modules having the same number as the thermal convection tunnels 25. Each secondary heat-dissipating fin module includes two opposing secondary heat-dissipating fins 30. The secondary heat-dissipating fins 30 are perpendicularly mounted on the top surface 12 of the heat-conducting base 10, and are arranged circumferentially around the primary heat-dissipating fins 20. A spacing between two secondary heat-dissipating fins forms a secondary thermal convection tunnel 35. Each secondary thermal convection tunnel 35 and a corresponding thermal convection tunnel 25 cooperatively form a tunnel with a straight axis, which has a better thermal convection effect and improves thermal convection speed. The secondary heat-dissipating fins 30 facilitate expansion of the heat dissipating area. In this preferred embodiment, each secondary heat-dissipating fin 30 is plate-like. Each secondary thermal convection tunnel 35 has an inner section proximal to the thermal convection tunnel 25, and an outer section proximal to the periphery of the top surface 12. The inner section is smaller than the outer section. The secondary thermal convection tunnel 30 widens gradually from the inner section to the outer section, which facilitates improving heat convection speed.

The heat sink further includes tertiary heat-dissipating fin modules having the same number as the secondary thermal convection tunnels 35. Each tertiary heat-dissipating fin module includes two oppositely disposed tertiary heat-dissipating fins 40. The tertiary heat-dissipating fins are mounted on the top surface 12 of the heat-conducting base 10 perpendicularly, and are arranged circumferentially around the secondary heat-dissipating fins 30. A spacing between two tertiary heat-dissipating fins 40 forms a tertiary thermal convection tunnel 45. Each tertiary thermal convection tunnel 45, a corresponding secondary thermal convection tunnel 35, and a corresponding thermal convection tunnel 25 cooperatively form a tunnel with a straight axis, which has a better thermal convection effect and improves heat convection speed. The tertiary heat-dissipating fins 40 facilitate expansion of the heat dissipating area. In this preferred embodiment, each tertiary heat-dissipating fin 40 is plate-like. Each tertiary thermal convection tunnel 45 has an inner section proximal to the secondary thermal convection tunnel 35, and an outer section proximal to the periphery of the top surface 12. The inner section is smaller than the outer section. The tertiary thermal convection tunnel 40 widens gradually from the inner section to the outer section, which facilitates improving thermal convection speed.

The heat sink further includes a plurality of auxiliary heat-dissipating fins 50. Between every two adjacent tertiary heat-dissipating fin modules lies an auxiliary heat-dissipating fin 50, which facilitates expansion of the heat dissipating area. Advantageously, between every two adjacent secondary heat-dissipating fin modules lies an auxiliary heat-dissipating fin 50, to expand the heat dissipating area. Each auxiliary heat-dissipating fin 50 is mounted on the top surface 12 of the heat-conducting base 10 perpendicularly.

In this preferred embodiment, the heat-conducting base 10, the primary heat-dissipating fins 20, the secondary heat-dissipating fins 30, the tertiary heat-dissipating fins 30 and the auxiliary heat-dissipating fins 50 are monolithic, namely, molded from a single piece of material. The heat sink is plated with a black radiation layer, so that the heat sink can transfer heat efficiently through heat radiation. Each primary heat-dissipating fin 20, each secondary heat-dissipating fin 30, each tertiary heat-dissipating fin 40 or auxiliary heat-dissipating fin 50 has a plurality of raised lines spaced apart from each other and mounted on a sidewall thereof. The raised lines facilitate expansion of the heat-dissipation area.

The heat sink can transfer heat through heat conduction, heat convection and heat radiation. The heat sink can efficiently dissipate heat in all directions.

1. A heat sink, comprising:
a heat-conducting base having a top surface; and
a plurality of primary heat-dissipating fins mounted perpendicularly on the top surface of the heat-conducting base, spaced apart from each other and arranged circumferentially to form a cylindrical convection tunnel,
wherein a spacing between every two adjacent primary heat-dissipating fins forms a thermal convection tunnel, and each thermal convection tunnel is open to the cylindrical convection tunnel.

2. The heat sink of claim 1, wherein each primary heat-dissipating fin is plate-like, each thermal convection tunnel has an inner section proximal to the center portion of the top surface and an outer section proximal to the periphery of the top surface, the outer section being larger than the inner section, the thermal convection tunnel widening gradually from the inner section to the outer section, wherein the thermal convection tunnels are arranged circumferentially and evenly around the cylindrical convection tunnel, and further wherein the vertical projection of an axis of the cylindrical convection tunnel onto the top surface of the heat-conducting base defines a center point, and an axis of each thermal convection tunnel extends through the center point.

3. The heat sink of claim 2, further comprising secondary heat-dissipating fin modules having the same number as the thermal convection tunnels, each secondary heat-dissipating fin module comprising two opposite secondary heat-dissipating fins, the secondary heat-dissipating fins mounted perpendicularly on the top surface of the heat-conducting base and arranged circumferentially around the primary heat-dissipating fins, and further wherein a spacing between two secondary heat-dissipating fins forms a secondary thermal convection tunnel, and each secondary thermal convection tunnel and a corresponding thermal convection tunnel cooperatively form a tunnel with a straight axis.

4. The heat sink of claim 3, further comprising tertiary heat-dissipating fin modules having the same number as the secondary thermal convection tunnels, each tertiary heat-dissipating fin module comprising two opposite tertiary heat-dissipating fins, the tertiary heat-dissipating fins mounted perpendicularly on the top surface of the heat-conducting base and arranged circumferentially around the secondary heat-dissipating fins, a spacing between two tertiary heat-dissipating fins forming a tertiary thermal convection tunnel, and each tertiary thermal convection tunnel, a corresponding secondary thermal convection tunnel and a corresponding thermal convection tunnel cooperatively form a tunnel with a straight axis.

5. The heat sink of claim 4, further comprising a plurality of auxiliary heat-dissipating fins disposed between every two adjacent tertiary heat-dissipating fin modules and/or between every two adjacent secondary heat-dissipating fin modules, wherein each auxiliary heat-dissipating fin is perpendicularly mounted on the top surface of the heat-conducting base.

6. The heat sink of claim 5, wherein the heat-conducting base, the primary heat-dissipating fins, the secondary heat-dissipating fins, the tertiary heat-dissipating fins and the auxiliary heat-dissipating fins are monolithic.

7. The heat sink of claim 5, wherein each primary heat-dissipating fin, each secondary heat-dissipating fin, and each tertiary heat-dissipating fin or auxiliary heat-dissipating fin has a plurality of raised lines spaced apart from each other and mounted on a sidewall thereof.

8. The heat sink of claim 4, wherein each secondary heat-dissipating fin is plate-like, each secondary thermal convection tunnel has an inner section proximal to the thermal convection tunnel, and an outer section proximal to the periphery of the top surface, and the inner section is smaller than the outer section.

9. The heat sink of claim 4, wherein each tertiary heat-dissipating fin is plate-like, each tertiary thermal convection tunnel has an inner section proximal to the secondary thermal convection tunnel, and an outer section proximal to the periphery of the top surface, and the inner section is smaller than the outer section.

10. The heat sink of claim 1, wherein the top surface of the heat-conducting base is a planar surface, a concave surface, or a convex surface.

11. The heat sink of claim 1, wherein the heat sink is plated with a black radiation layer.
